(19) United States
(12) Patent Application Publication
(10) Pub. No.: US 2005/0003167 A1
(43) Pub. Date: Jan. 6, 2005

(54) Subsurface printed pressure sensitive composite

(76) Inventors: David A. Kitch, Brimfield, MA (US); Philip R. Emery, Palmer, MA (US); Patrick W. Hunter, Hartland, WI (US); Stephen D. Tomas, Fiskdale, MA (US); James M. Casey, East Brookfield, MA (US)

Correspondence Address: Gauthier & Connors LLP, Suite 3300, 225 Franklin Street, Boston, MA, 02110, US

(21) Appl. No.: 10/848,818

(22) Filed: May 19, 2004

Related U.S. Application Data
(60) Provisional application No. 60/472,373, filed on May 21, 2003.

(51) Int. Cl. B41M 5/00

(52) U.S. Cl. 428/195.1

(57) ABSTRACT

A multilayer composite comprises a printable facestock with a carrier sheet separably laminated directly to its top surface. The facestock is a dimensionally unstable and/or low flexural stiffness transparent film having a thickness not greater than about 4.0 mils. In subsequent processing, graphics are printed on the bottom surface of the facestock followed by the application of pressure sensitive adhesive and a release liner. The liner is removable, allowing the composite to be adhered to a substrate, with the graphics remaining beneath and protected by the facestock. The carrier sheet is separable from the top surface of the facestock, either before or following removal of the release liner.

### CROSS REFERENCE TO RELATED APPLICATION

This application claims priority from Provisional Application Ser. No. 60/472,373 filed May 21, 2003.

### BACKGROUND OF THE INVENTION

1. Field of the Invention

This invention relates to facestocks that are difficult or impossible to process, either because they become dimensionally unstable when exposed to elevated temperatures and/or increased tension, or because they have low flexural stiffness. The invention is concerned in particular with the temporary incorporation of such facestocks with carrier sheets in laminated composites having exposed surfaces on which graphics, adhesives and release liners may be applied, followed by separation of the carrier sheets from the facestocks, thereby allowing the graphics to remain protected beneath the facestocks when they are adhesively applied to substrates.

2. Description of the Prior Art

As herein employed, the term “facestock(s)” means transparent films having thicknesses not greater than about 4.0 mils and preferably selected from the group consisting of vinyl, urethane, acrylic, polyester, polypropylene, polyethylene, and blends thereof. Facestocks are considered to be “dimensionally unstable” if in an unrestrained state, they change dimensionally more than 1.0% in the machine or crossmachine direction. Dimensions are measured in accordance with ASTM D1204 using 6×6 inch samples heated to temperatures above about 140° F. for a period of 24 hours and/or subjected to tension greater than about 0.5 PLI (pounds per linear inch). “Low flexural stiffness “facestocks are those with Handle-o-Meter units not greater than 30 grams when measured in accordance with ASTM D2923 Standard Test Method for Rigidity of Polyolefin Film and Sheeting, using 6×6 inch samples, and with the beam cantilevered to a neutral (0) weight with a 140 gram load cell. Readings are taken in the machine and cross machine directions with the top surface of the sample facing up, and again with the top surface of the sample facing down, with the value herein reported being the average of these four readings in grams.

In accordance with conventional practice, a dimensionally unstable and/or low flexural stiffness film is formed, for example, by coating vinyl onto a casting sheet. A release liner is then laminated to the exposed surface of the cast vinyl film by means of a pressure sensitive adhesive. The casting sheet is then stripped from the opposite surface of the cast vinyl film, leaving that surface exposed for subsequent printing. In many applications, the printed graphics must then be protected by various techniques, e.g., the use of overprint varnishes, pressure sensitive coated film overlaminates, heat seal overlaminates, cured in place adhesive overlaminates, etc.

U.S. Pat. No. 4,517,044 (Arnold) discloses a different approach where the graphics are reverse printed on the underside of a thick protective layer of an engineered cured polymer, with the resulting cured decals having elongations below 25%.

While these methods succeed in achieving the required protection for the printed graphics, they do so at the cost of limiting the selection of films that can be used, and/or sacrificing conformability, i.e., the stiffness of the resulting composites inhibits their ability to conform to curved and/or rough surfaces.

### SUMMARY OF THE INVENTION

In accordance with the present invention, a dimensionally unstable and/or low flexural stiffness facestock is laminated directly to a surface of a carrier sheet. The carrier sheet surface may optionally be modified, e.g., by the application of a heat sensitive layer. Lamination is preferably achieved under conditions of elevated temperature and/or pressure, and preferably without the addition of a separate adhesive interlayer. The carrier sheet serves to strengthen the facestock against damaging distortion during subsequent processing. Thus, the exposed side of the facestock may be reverse printed, and then combined with a pressure sensitive adhesive carried on a release liner. The bond at the interface between the carrier sheet and facestock is strong enough to resist delamination during processing, yet its strength is such as to allow subsequent clean separation of the carrier sheet without distorting or otherwise damaging the facestock. The carrier sheet may be removed either before or after the release liner is removed and the printed facestock is adhesively secured to a substrate. Prior removal of the carrier sheet enables the more pliant facestock to conform more readily to the contour and surface characteristics of the substrate. In all cases, the printed graphics remain covered by the facestock, which serves as a protection from damage resulting from abrasion, exposure to the elements, etc.

### DETAILED DESCRIPTION OF THE INVENTION

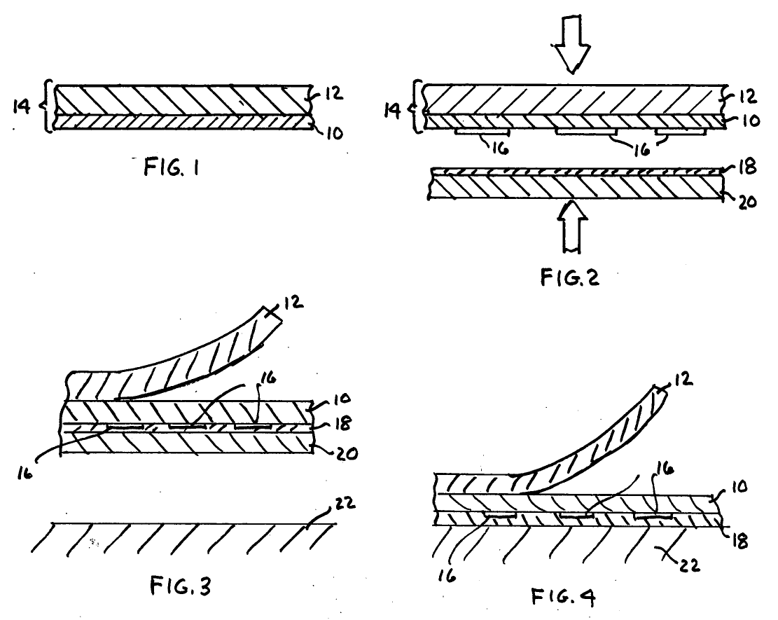

With reference initially to FIG. 1, a dimensionally unstable and/or low flexural stiffness facestock 10 is laminated to a carrier sheet 12 to produce a composite 14. The resulting stiffness of the composite, when measured as previously described in accordance with ASTM D2923 is greater than about 60 grams. The carrier sheet may be a film selected from the group consisting of polyester, polypropylene, polystyrene and surface modified versions thereof, or it may comprise a composite such as extrusion coated paper or film. The facestock 10 may be any of those previously identified, with a thickness preferably between about 0.25 to 3.5 mils, and most preferably between about 1 to 3 mils, and with elongation characteristics as measured in accordance with ASTM D-882 greater than about 50%, and most preferably greater than about 100%. The carrier sheet 12 is preferably, also although not necessarily, transparent.

Lamination is achieved under conditions of elevated temperature and/or pressure, without the interposition of a separate adhesive interlayer. The resulting bond at the facestock/carrier sheet interface is less than the tensile strength of each component of the composite, and preferably less than the yield strength of facestock. Bond strengths as measured in accordance with FINAT Test Method #3 (“FTM3”) are preferably less than 200 grams per 2 inch width, with bond strengths below 100 grams being more preferable and less than 60 grams being most preferred.

The stiffness and tensile strength of the carrier sheet 12 is sufficient to prevent the facestock 10 from distorting more than 1.0% during processing involving exposure of the composite to temperatures above about 140° F. and/or tension greater than about 0.5 PLI. The bond strength of the laminate allows the carrier sheet 12 to transport the facestock 10 through the various processing steps without delamination, while still allowing for relatively easy clean separation when its carrier function is no longer required.

As shown in FIG. 2, the composite 14 may then be subjected to further processing, including for example the reverse printing of graphics 16 on the exposed underside of facestock 10, followed by the application of a pressure sensitive adhesive 18 carried on a release liner 20.

As shown in FIG. 3, the carrier sheet 12 may then be removed from the underlying printed facestock 10 prior to continued processing, e.g., die cutting and stripping to produce individual labels. Finally, the release liner 20 may be removed to expose the adhesive 18 for application to a substrate 22.

Alternatively, as shown in FIG. 4, the carrier sheet 12 may remain in place until after the release liner 20 has been removed and the adhesive 18 brought into contact with the substrate 22.

Removal of both the carrier sheet 12 and release liner 20 prior to application takes full advantage of the conformability of the facestock 10, which is highly desirable when the substrate is curved and/or uneven. On the other hand, retaining the carrier sheet 12 until after application takes advantage of the added stiffness of the carrier sheet, which may be desirable for example when applying graphics to floors, walls and other large surface areas.

In all cases, the material selection and thickness of the facestock component 10 is such as to provide a high degree of flexibility and conformability, while also safeguarding the underlying graphics 16 from damaging abrasion and/or exposure to harmful elements in the environment.

1. A multilayer composite comprising a facestock having bottom and top surfaces, at least the bottom surface of said facestock being printable, and a carrier sheet laminated directly to the top surface of said facestock at an interface therebetween.

2. The composite of claim 1 wherein said facestock comprises a film selected from the group consisting of vinyl, urethane, acrylic, polyester, polypropylene, polyethylene, and blends thereof.

3. The composite of claim 1 wherein said facestock distorts more than 1.0% in either the machine or cross machine directions when in an unrestrained state and exposed to temperatures above about 140° F.

4. The composite of claims 1 or 3 wherein said facestock distorts more than 1.0% in either the machine or cross machine directions when subjected to tension greater than about 0.5 PLI.

5. The composite of claims 1, 2, 3 or 4 wherein said facestock has low flexural stiffness.

6. The composite of claim 1 wherein the thickness of said facestock is between about 0.25 to 3.5 mils.

7. The composite of claim 6 wherein said thickness is between about 1 and 3 mils.

8. The composite of claim 1 wherein said facestock has elongation characteristics as measured in accordance with ASTM D-822 greater than 50% in at least one direction.

9. The composite of claim 8 wherein said elongation characteristics are greater than 100% in at least one direction.

10. The composite of claim 1 having a stiffiness greater than about 60 grams.

11. The composite of claim 1 wherein the bond strength at said interface is less than the respective tensile strengths of said facestock and said carrier sheet.

12. The composite of claim 1 wherein the bond strength at said interface is less than the yield strength of said facestock.

13. The composite of claim 1 wherein the bond strength at said interface as measured in accordance with FTM3 is less than 200 grams per 2 inch width.

14. The composite of claim 13 wherein said bond strength is less than 100 grams per 2 inch width.

15. The composite of claim 14 wherein said bond strength is less than 60 grams per 2 inch width.

16. The composite of claim 3 wherein the stiffness and tensile strength of said carrier sheet is such as to prevent said distortion.

17. The composite of claim 1 further comprising a liner releasably adhered by means of a pressure sensitive adhesive to the bottom surface of said facestock.

18. The composite of claim 17 further comprising graphics interposed between the bottom surface of said facestock and said pressure sensitive adhesive.

19. The composite of claim 18 wherein said graphics are printed on the bottom surface of said facestock.

19. The composite of claim 1 wherein said carrier sheet comprises a film selected from the group consisting of polyester, polypropylene and polystyrene and surface modifications thereof.

20. The composite of claim 1 wherein said carrier sheet is selected from the group consisting of extrusion coated paper and extrusion coated film.
